(19) United States
(12) Patent Application Publication
(10) Pub. No.: US 2026/0208890 A1
(43) Pub. Date: Jul. 23, 2026

(54) DRONE-BASED DELIVERY APPARATUS AND METHOD

(71) Applicant: Electronics and Telecommunications Research Institute, Daejeon (KR)

(72) Inventors: Hanseob LEE, Daejeon (KR); Dae Hee KIM, Daejeon (KR); Do Huy WANG, Daejeon (KR)

(21) Appl. No.: 19/454,256

(22) Filed: Jan. 20, 2026

(30) Foreign Application Priority Data
Jan. 20, 2025 (KR) 10-2025-0008351
Jan. 8, 2026 (KR) 10-2026-0003647

(51) Int. Cl. B64U 10/13; B64U 10/60; B64U 101/64

(52) U.S. Cl. CPC B64U 10/13; B64U 10/60; B64U 2101/64; B64U 2201/10

(57) ABSTRACT

A drone-based delivery apparatus and method are disclosed for accurately and stably delivering goods to a target marker position in environments involving movement and vibration, such as vessels. The apparatus comprises a delivery drone configured to hover at a target location, a delivery box suspended by a wire, a sensor unit that recognizes a marker using a downward image and calculates a relative position error, an auxiliary propulsion unit that adjusts the horizontal position and attitude of the delivery box, and a controller. The controller accumulates relative position errors over time and selectively controls either the hovering position of the delivery drone or the auxiliary propulsion of the delivery box based on the accumulated error. Through this configuration, goods can be precisely delivered without the drone directly landing on the vessel, thereby improving delivery accuracy and operational safety in marine environments.

### CROSS-REFERENCE TO RELATED APPLICATION

This application claims priority to Korean Patent Applications No. 10-2025-0008351 filed on Jan. 20, 2025, and No. 10-2026-0003647 filed on Jan. 8, 2026, with the Ministry of Intellectual Property Office (MOIP), the entire contents of which are hereby incorporated by reference.

### BACKGROUND

### 1. Technical Field

The present disclosure relates to a drone-based delivery apparatus and method, and more particularly, to a drone-based delivery apparatus and method for delivering goods to a vessel or the like.

### 2. Description of the Related Art

The parcel logistics market is continuously increasing, and in recent years, the market size has been rapidly growing in cooperation with the online distribution industry. As the market size increases, cases of providing delivery services using drones in various fields are increasing, and one of the cases is a service for delivering ship supplies.

Large vessels such as cargo ships are unable to dock at a pier and are therefore anchored offshore several kilometers away, and necessary goods are supplied by traveling to and from land using small boats. When goods are delivered using drones, goods can be delivered more safely and quickly, and thus such a delivery method is attracting attention as a next-generation drone delivery industry.

In order to deliver ship supplies, landing a drone on a vessel is more dangerous than landing on the ground. Since a vessel slightly moves according to water flow, delivering only goods by attaching a wire to a cargo box rather than actually landing on the vessel is safer. However, existing wire-based delivery services do not utilize image-based precision delivery technology, and even when a camera is mounted under a delivery drone to recognize a marker placed on the vessel, the field of view of the camera may be blocked as the goods move downward along the wire, and thus, according to the conventional methods, it is impossible to deliver ship supplies to an accurate position.

### SUMMARY

An object of the present disclosure for solving the above-described problems is to provide a drone-based delivery apparatus capable of accurately and stably delivering goods to a target marker position even in an environment in which movement and shaking occur, such as a vessel.

Another object of the present disclosure is to provide a drone-based delivery method capable of effectively correcting a delivery error without a drone directly landing on a vessel, thereby improving drop accuracy of goods and delivery safety.

The drone-based delivery apparatus for delivering goods to a marker position, may comprise a delivery drone, a delivery box, a sensor unit, an auxiliary propulsion unit, and a controller. The delivery drone may be configured to perform hovering flight after flying to a target position. The delivery box may be connected to the delivery drone to be movable upward and downward along a wire and configured to accommodate goods. The sensor unit may be attached to the delivery box and configured to recognize the marker using a downward image and to calculate a relative position error of the delivery box with respect to the marker. The auxiliary propulsion unit may be configured to control a horizontal position and an attitude of the delivery box based on the relative position error. The controller may be configured to, after driving the auxiliary propulsion unit, accumulate a newly measured relative position error, and to selectively control flight of the delivery drone or driving of the auxiliary propulsion unit based on an accumulated relative position error.

The controller may be configured to control a hovering position of the delivery drone to move toward the marker, based on the accumulated relative position error exceeding a preset reference value, or drive the auxiliary propulsion unit to move a position of the delivery box toward the marker, based on the accumulated relative position error not exceeding the preset reference value.

The controller may comprise: a delivery drone control system configured to control flight of the delivery drone; a wire control system configured to control the wire that performs upward and downward movement of the delivery box; and a delivery box control system configured to control a position and an attitude of the delivery box.

The delivery drone control system may comprise a flight control unit configured to control the delivery drone to perform hovering flight after flying to the target position, and a hovering-position control unit configured to control movement of the hovering position of the delivery drone based on the accumulated relative position error.

The sensor unit may comprise one or more of an image sensor configured to capture a downward image of the delivery box to recognize the marker, a distance sensor configured to measure a relative distance between the marker and the delivery box, or a position sensor configured to identify a position of the delivery box.

The auxiliary propulsion unit may comprises a plurality of auxiliary propellers driven to perform horizontal movement and attitude control of the delivery box, and a plurality of motors configured to respectively drive the auxiliary propellers.

The auxiliary propellers may be respectively disposed on both sides of the delivery box.

The auxiliary propellers may be respectively disposed on four side surfaces of the delivery box.

The auxiliary propellers may be pivotably mounted to side surfaces of the delivery box.

The marker may be a marker disposed on a vessel.

The drone-based delivery method performed by a controller of a drone-based delivery apparatus for delivering goods to a marker position, may comprise: controlling a delivery drone to fly until the delivery drone reaches a target position; controlling the delivery drone to perform hovering, based on the target position being reached; controlling a delivery box connected to the delivery drone to descend along a wire; recognizing a marker based on a downward image obtained using a sensor unit attached to the delivery box; calculating a relative position error of the delivery box with respect to the marker; accumulating the calculated relative position error to a previously calculated relative position error; until the accumulated relative position error becomes less than a reference value, calculating and accumulating the relative position error and controlling a position of the delivery box by selectively controlling at least one of flight of the delivery drone or driving of an auxiliary propulsion unit based on the accumulated relative position error; and opening a lower hatch of the delivery box such that goods are dropped to the marker position.

The drone-based delivery method may further comprise controlling, based on the accumulated relative position error exceeding a preset reference value, a hovering position of the delivery drone to be moved toward the marker.

The drone-based delivery method may further comprise controlling, based on the accumulated relative position error not exceeding a preset reference value, the auxiliary propulsion unit to be driven to move a position of the delivery box toward the marker.

The downward image may be obtained using an image sensor configured to capture a downward image of the delivery box.

The relative position error may be obtained using relative distance information between the marker and the delivery box recognized based on the downward image.

The drone-based delivery method of claim 11, wherein driving of the auxiliary propulsion unit is performed through driving of a plurality of auxiliary propellers comprised in the auxiliary propulsion unit.

The driving of the auxiliary propulsion unit may be performed through driving of auxiliary propellers respectively disposed on both sides of the delivery box.

The driving of the auxiliary propulsion unit may be performed through driving of auxiliary propellers respectively disposed on four side surfaces of the delivery box.

The driving of the auxiliary propulsion unit may be performed after unfolding a plurality of propellers pivotably mounted to side surfaces of the delivery box.

The marker may be a marker disposed on a vessel.

According to the present disclosure as described above, based on a configuration in which a marker is recognized and a relative position error between a delivery box and the marker is calculated through a sensor unit provided in the delivery box rather than through a delivery drone, obstruction of the sensor unit by the delivery box is prevented, and the delivery position can be precisely recognized, thereby providing an effect of improving delivery accuracy.

In addition, based on a configuration in which the relative position error is accumulated and managed over time, an effect of mitigating an influence of instantaneous errors caused by waves, wind, wire vibration, etc. is provided.

In addition, based on a configuration in which at least one of flight control of the delivery drone or auxiliary propulsion control of the delivery box is selectively performed based on the accumulated relative position error, an effect is provided in which the delivery position can be stably corrected even when exceeding a local control limit of the delivery box.

In addition, based on a configuration in which a horizontal position and an attitude of the delivery box are controlled using an auxiliary propulsion unit, an effect is provided in which precise alignment with respect to the marker position becomes possible even when the delivery box is suspended by a wire.

In addition, based on a configuration in which a plurality of auxiliary propellers are disposed on both sides or multiple surfaces of the delivery box, an effect is provided in which horizontal movement and rotational control of the delivery box can be simultaneously performed, thereby improving precision delivery performance.

In addition, based on a configuration in which the auxiliary propellers are pivotably mounted to side surfaces of the delivery box, an effect is provided in which air resistance and external interference can be minimized when the auxiliary propellers are not in use.

### BRIEF DESCRIPTION OF THE DRAWINGS

In order that the disclosure may be well understood, there will now be described various forms thereof, given by way of example, reference being made to the accompanying drawings, in which:

FIG. 1 is a block diagram of a drone-based delivery apparatus according to exemplary embodiments of the present disclosure.

FIG. 2 is a front view of the drone-based delivery apparatus according to exemplary embodiments of the present disclosure.

FIG. 3 is a diagram illustrating a state in which a delivery box is lowered by operation of a wire driving unit of the drone-based delivery apparatus illustrated in FIG. 2.

FIG. 4 and FIG. 5 are front views illustrating the delivery box in detail.

FIG. 6 is a diagram for explaining position control of the delivery box.

FIG. 7A and FIG. 7B are flowcharts of a drone-based delivery method according to exemplary embodiments of the present disclosure.

FIG. 8 is a block diagram illustrating a generalized configuration of an apparatus for performing the drone-based delivery method according to exemplary embodiments of the present disclosure.

### DETAILED DESCRIPTION

For a clearer understanding of the features and advantages of the present disclosure, exemplary embodiments of the present disclosure will be described in detail with reference to the accompanied drawings. However, it should be understood that the present disclosure may be not be limited to particular embodiments disclosed herein but comprises all modifications, equivalents, and alternatives falling within the spirit and scope of the present disclosure. In the drawings, similar or corresponding components may be designated by the same or similar reference numerals.

The terminologies including ordinals such as “first” and “second” or another identifiers such as “A” and “B” may be used to discriminate a component from the other ones but may not be intended to be limiting to a specific component. For example, a second component may be referred to as a first component and, similarly, a first component may also be referred to as a second component without departing from the scope of the present disclosure. As used herein, the term “and/or” may comprise a presence of one or more of the associated listed items and any and all combinations of the listed items.

When a component is referred to as being “connected” or “coupled” to another component, the component may be directly connected or coupled logically or physically to the other component or indirectly through an object therebetween. Contrarily, when a component is referred to as being “directly connected” or “directly coupled” to another component, it is to be understood that there is no intervening object between the components. Other words used to describe the relationship between elements should be interpreted in a similar fashion.

The terminologies may be used herein for the purpose of describing particular exemplary embodiments only and may not be intended to limit the present disclosure. The singular forms comprise plural referents as well unless the context clearly dictates otherwise. Also, the expressions “comprises” or “comprises” may be used to refer a presence of a combination of stated features, numbers, processing steps, operations, elements, or components, but may not be intended to preclude a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with their meanings in the context of related literatures and will not be interpreted as having ideal or excessively formal meanings unless explicitly defined in the present application.

Hereinafter, preferred exemplary embodiments according to the present disclosure will be described in detail with reference to the accompanying drawings.

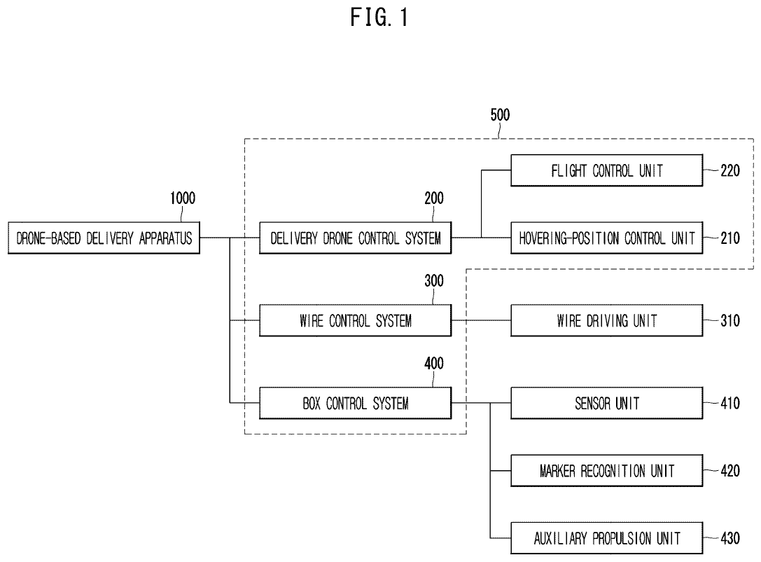

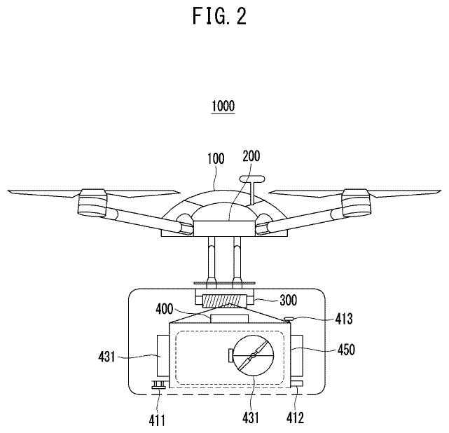

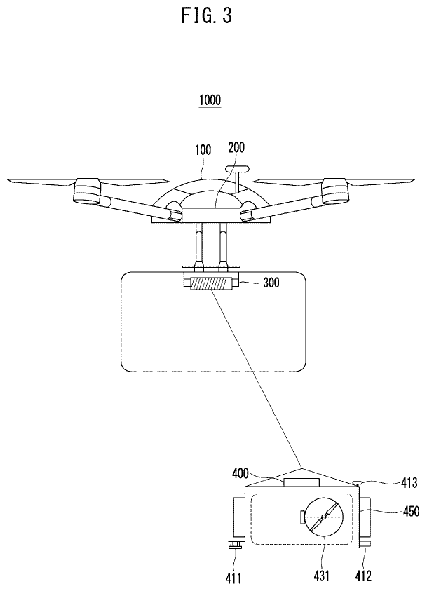

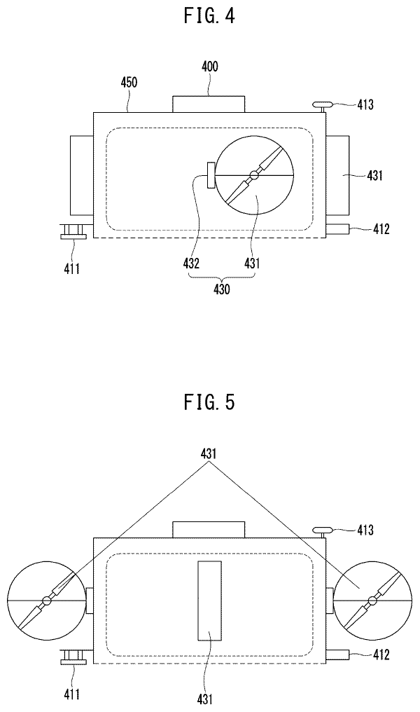

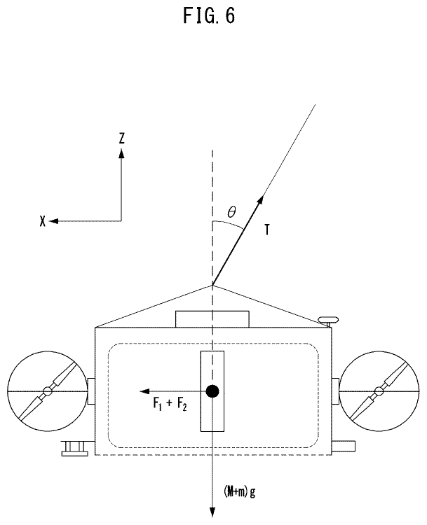

FIG. 1 is a block diagram of a drone-based delivery apparatus according to exemplary embodiments of the present disclosure, and FIG. 2 is a front view of the drone-based delivery apparatus according to exemplary embodiments of the present disclosure. FIG. 3 is a diagram illustrating a state in which a delivery box is lowered by operation of a wire driving unit of the drone-based delivery apparatus illustrated in FIG. 2, and FIG. 4 and FIG. 5 are front views illustrating the delivery box in detail.

As disclosed in FIG. 1 to FIG. 5, a drone-based delivery apparatus 1000 according to an exemplary embodiment of the present disclosure is a drone-based delivery apparatus 1000 configured to deliver goods to a marker position, and may comprise a delivery drone 100, a delivery box 450, a sensor unit 410, an auxiliary propulsion unit 430, and a controller 500. The marker may be a marker disposed on a vessel.

The marker may be installed on a deck of the vessel, a cargo space, or a specific position where goods can be handed over, and may comprise a visual pattern, a geometric shape, or an identifiable mark.

The delivery drone 100 may be configured to perform hovering flight after flying to a target position. The delivery drone 100 may fly to the target position through waypoint flight and then perform hovering. The waypoint flight may be automatically performed according to a preset route or coordinates, and the hovering may refer to an operation in which the delivery drone 100 maintains a position in the air while lowering and precisely controlling the delivery box 450.

The delivery box 450 may be connected to the delivery drone 100 and may be configured to move upward and downward along a wire and to accommodate goods. The wire may support a load of the delivery box 450 while connecting the delivery drone 100 and the delivery box 450, and a length of the wire may be variably controlled by a wire driving unit 310 controlled by a wire control system 300.

The sensor unit 410 may be attached to the delivery box 450 and may be configured to recognize the marker using a downward image so that the controller 500 calculates a relative position error of the delivery box with respect to the marker. The sensor unit 410 may comprise at least one of an image sensor 411 for capturing a downward image of the delivery box to recognize the marker, a distance sensor 412 for measuring a relative distance between the marker and the delivery box, or a position sensor 413 for identifying a position of the delivery box 450. The relative position error may comprise a horizontal position difference, a rotational direction error, or a combination thereof between the delivery box 450 and the marker.

The image sensor 411 may comprise, for example, a camera such as a CCD or CMOS. The distance sensor 412 may comprise, for example, a one-dimensional LiDAR. The position sensor 413 may comprise a GPS sensor. Information obtained from the sensor unit 410 may be used independently or in combination, and through this, a current position of the delivery box 450 and a relative positional relationship with respect to the marker may be calculated more precisely.

The auxiliary propulsion unit 430 may control a horizontal position and an attitude of the delivery box based on the relative position error. The auxiliary propulsion unit 430 may comprise a plurality of auxiliary propellers 431 and a plurality of motors 432. The plurality of auxiliary propellers 431 may be driven for horizontal movement and attitude control of the delivery box. The plurality of motors 432 may respectively drive the auxiliary propellers.

Accordingly, the auxiliary propulsion unit 430 may perform horizontal movement and rotational control even when the delivery box 450 is suspended by a wire.

The plurality of auxiliary propellers 431 may be respectively disposed on both sides of the delivery box 450. As the plurality of auxiliary propellers 431 are disposed on both sides of the delivery box 450, thrust generated by each auxiliary propeller 431 may be independently controlled. Accordingly, when the auxiliary propellers 431 are driven with the same magnitude of thrust, the delivery box 450 may be controlled to move in a horizontal direction, and when the auxiliary propellers 431 are driven with different magnitudes of thrust, a rotational moment may be generated in the delivery box 450 to control an attitude of the delivery box. As a result, horizontal position control and attitude control of the delivery box 450 may be simultaneously performed, thereby enabling precise alignment with respect to the marker position.

In addition, the plurality of auxiliary propellers 431 may be disposed on four side surfaces of the delivery box 450. When the auxiliary propellers 431 are disposed on the four side surfaces as described above, the delivery box 450 may be moved along an X-axis and a Y-axis in addition to generation of the thrust and rotational force described above.

The auxiliary propellers 431 may be pivotably mounted to side surfaces of the delivery box 450. Based on such a pivotable structure, the auxiliary propellers 431 may be deployed by being unfolded about a hinge to generate thrust during use, and may be maintained in a folded state when not in use, thereby minimizing air resistance or external interference.

The controller 500 may accumulate a newly measured relative position error after driving the auxiliary propulsion unit 430, and may selectively control one of flight of the delivery drone 100 or driving of the auxiliary propulsion unit 430 based on the accumulated relative position error. Here, the accumulated relative position error may refer to an accumulated state reflecting a change in relative position errors repeatedly measured over time rather than an error at a single time point.

The controller 500 may control the delivery drone 100 to move a hovering position toward the marker when the accumulated relative position error exceeds a preset reference value, or may control the auxiliary propulsion unit 430 to move the delivery box 450 toward the marker when the accumulated relative position error does not exceed the preset reference value. Accordingly, by changing the hovering position of the delivery drone 100 only when local position correction by the delivery box 450 reaches a limit, stability and energy efficiency of the entire system can be improved.

In addition, even when an instantaneous relative position error occurs due to movement of a vessel caused by waves and currents, swinging of a wire, or rotation of a delivery box, the instantaneous relative position error may be mitigated by applying the accumulated relative position error.

The controller 500 may comprise a delivery drone control system 200, a wire control system 300, and a delivery box control system 400. The control systems 200, 300, and 400 may be communicatively connected to each other and may cooperatively perform an operation sequence throughout a delivery process.

The delivery drone control system 200 may control flight of the delivery drone 100. The wire control system 300 may control a wire that performs upward and downward movement of the delivery box 450. For example, the wire control system 300 may control a payout speed and a length of the wire such that the delivery box 450 reaches a height at which marker recognition is possible.

The delivery box control system 400 may control a position and an attitude of the delivery box 450. The delivery box control system 400 may operate in conjunction with the sensor unit 410, a marker recognition unit 420, and the auxiliary propulsion unit 430 such that the delivery box 450 is stably aligned above a marker position.

The delivery drone control system 200 may comprise a flight control unit 220 and a hovering-position control unit 210. The flight control unit 220 may control the delivery drone 100 to perform hovering after flying to the target position. The hovering-position control unit 210 may control movement of a hovering position of the delivery drone 100 based on the accumulated relative position error.

As described above, the drone-based delivery apparatus 1000 according to the present exemplary embodiment may hierarchically combine precise control of the delivery box 450 and flight control of the delivery drone 100, thereby enabling stable and precise delivery even in an environment in which movement or shaking exists, such as a vessel.

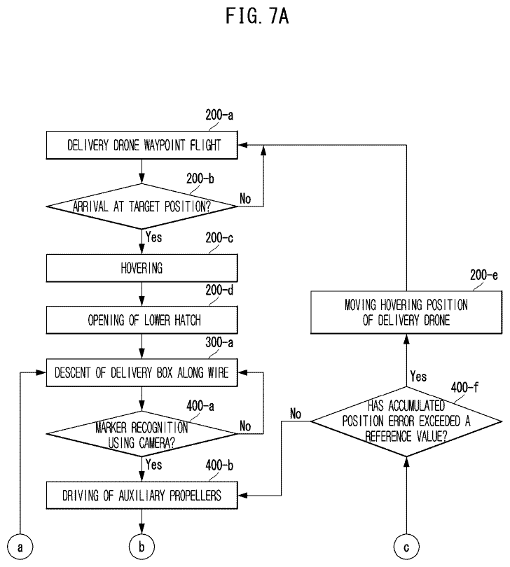

FIG. 6 is a diagram for explaining position control of the delivery box. More specifically,

FIG. 6 is a diagram for explaining a free-body diagram (FBD) for calculating thrust required for auxiliary propellers in order to control a position of the delivery box.

First, a force equilibrium equation in a Z-direction may be expressed as shown in Equation 1 below.

$$\begin{matrix}\sum {F}_{z} : T cos θ = ( M + m ) g & T = \frac{( M + m ) g}{cos θ}\end{matrix} \qquad [ Equation 1 ]$$

In Equation 1 above, T represents tension, M represents a weight of the delivery box, and m represents a weight of the delivered goods.

Next, a force equilibrium equation in an X-direction may be expressed as shown in Equation 2 below.

$$\begin{matrix}\sum {F}_{x} : T sin θ = {F}_{1} + {F}_{2} = 2 F & {F}_{1} = F + Δ F & {F}_{2} = F - Δ F\end{matrix} \qquad [ Equation 2 ]$$

In Equation 2 above, F1 and F2 are thrusts of auxiliary propellers respectively disposed at positions facing each other. Since thrust is generated in a form of a conjugate force in left and right directions, thrust may be expressed as a sum and a difference between a force used for horizontal movement of the delivery box and a force responsible for rotation.

From Equation 1 and Equation 2 above, Equation 3 and Equation 4 below may be derived.

$$\frac{( M + m ) g}{cos θ} sin θ = 2 F \qquad [ Equation 3 ]$$

$$tan θ = \frac{2 F}{( M + m ) g} = \frac{( {x}_{c} + Δ x ) - {x}_{p}}{( {z}_{p} - {z}_{c} )} \qquad [ Equation 4 ]$$

In Equation 4, Δx is an absolute distance separated in an X-direction from a camera when a marker is recognized and a position is estimated through a downward camera, Xc is an X-axis coordinate value of the delivery box, Xp is an X-axis coordinate value of the delivery drone, Zc is a Z-axis coordinate value of the delivery box, and Zp is a Z-axis coordinate value of the delivery drone.

Accordingly, when the above equations are rearranged again, based on a position of the delivery drone, a position of the delivery box, and a relative distance from a camera when recognizing a marker, a force F to be input to the delivery box can be obtained as shown in Equation 5 below.

$$F = ( M + m ) g \frac{( {x}_{c} + Δ x ) - {x}_{p}}{2 ( {z}_{p} - {z}_{c} )} \qquad [ Equation 5 ]$$

In addition, since a delivery box being misaligned or rotated may be dangerous, a direction of the delivery box is controlled to always be the same direction as the delivery drone. In order to perform such control, rotation may be generated through a difference value between both propellers, and first, when an equilibrium equation for a moment is expressed, the equilibrium equation for the moment may be arranged as shown in Equation 6 below.

$$\begin{matrix}\sum {M}_{z} : {F}_{1} ( \frac{{l}_{2}}{2} + r ) - {F}_{2} ( \frac{{l}_{2}}{2} + r ) = {I}_{zz} α & {I}_{zz} = \frac{1}{12} ( {l}_{1}^{2} + {l}_{2}^{2} + {l}_{3}^{2} ) ( M + m )\end{matrix} \qquad [ Equation 6 ]$$

In Equation 6 above, 11, 12, and 13 represent an X-direction length, a Y-direction length, and a Z-direction length of the delivery box, respectively, r represents a radius of an auxiliary propeller, and Izz represents a moment of inertia about a vertical axis of the delivery box.

At this time, since a generated turning force occurs at a distance separated by a sum of half of a Y-direction size 12 of the delivery box and the radius r of the auxiliary propeller, the generated turning force may be expressed as described above, and at this time, the moment of inertia Izz may be expressed as shown on the right side of Equation 6 when it is assumed that mass distribution of a hexahedron is uniform. Here, when the conjugate force defined in Equation 2 is substituted and arranged, the result may be expressed as shown in Equation 7 below.

$$Δ F = \frac{( {l}_{1}^{2} + {l}_{2}^{2} + {l}_{3}^{2} ) ( M + m ) α}{12 ( {l}_{2} + 2 r )} \qquad [ Equation 7 ]$$

Based on the horizontal movement force arranged in Equation 5 and the turning force arranged in Equation 7, position control and heading control of the delivery box may be simultaneously performed using the auxiliary propellers.

Even though a force is applied in this manner, when F becomes Fmax and nevertheless Δx does not continuously decrease and is accumulated, and when the accumulated value exceeds a reference, the hovering position of the delivery drone is too far away from the marker, and thus a command is applied to the parent-vessel flight control system to move the current hovering position toward the marker.

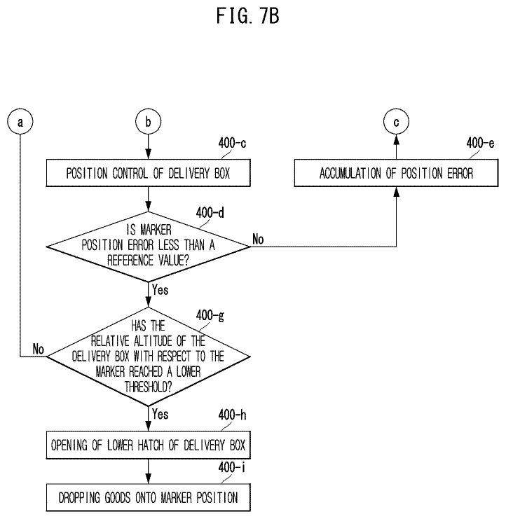

FIG. 7A and FIG. 7B are flowcharts of a drone-based delivery method according to exemplary embodiments of the present disclosure.

As shown in FIG. 7A and FIG. 7B, a drone-based delivery method according to an exemplary embodiment of the present disclosure is a drone-based delivery method performed by a controller of a drone-based delivery apparatus configured to deliver goods to a marker position, and may comprise controlling a delivery drone to fly until the delivery drone reaches a target position (200-a); controlling, based on the target position being reached (200-b), the delivery drone to perform hovering flight (200-c); controlling a delivery box connected to the delivery drone to descend along a wire (300a); recognizing a marker based on a downward image obtained using a sensor unit provided in the delivery box (400a); calculating a relative position error of the delivery box with respect to the marker (400-d); accumulating the calculated relative position error to a previously calculated relative position error (400e); until the accumulated relative position error becomes less than a reference value (400-f), calculating and accumulating the relative position error, and controlling a position of the delivery box (200-g) by selectively controlling at least one of flight of the delivery drone or driving of an auxiliary propulsion unit based on the accumulated relative position error; and opening a downward hatch of the delivery box such that goods are dropped to the marker position (400-h).

Such a drone-based delivery method may further comprise controlling, based on the accumulated relative position error exceeding a preset reference value (400-f), the hovering position of the delivery drone to be moved toward the marker (200e).

Such a drone-based delivery method may further comprise controlling, based on the accumulated relative position error not exceeding the preset reference value (400-f), the auxiliary propulsion unit to be driven (400-b) and a position of the delivery box to be moved toward the marker (400c).

Referring to FIG. 1 to FIG. 7B, when the above operations are described in more detail, the drone-based delivery method according to exemplary embodiments of the present disclosure is a method for precisely delivering goods to a marker position above a vessel anchored offshore using a delivery drone 100, and is performed by the delivery drone 100 and a delivery box 450 controller 450.

First, a delivery drone 100 loaded with delivered goods flies toward a target vessel based on preset waypoint information (in step 200-a). At this time, the delivery drone 100 performs waypoint flight until reaching a position of the target vessel while continuously checking a current position using GPS information or a navigation sensor. Based on the delivery drone 100 reaching above the target vessel (in step 200-b), the delivery drone 100 is controlled to maintain a hovering state at the position (in step 200-c).

Based on the delivery drone entering the hovering state, a hatch formed on a lower portion of a cargo box is opened (in step 200-d), and the delivery box 450 is controlled to descend along a wire by the wire control system 300. While descending to near an upper portion of the vessel, the delivery box 450 acquires a downward image using an image sensor 411 disposed to face downward.

The delivery box control system 400 determines whether a marker disposed on the upper portion of the vessel exists based on the obtained downward image (in step 400-a). Based on the delivery box 450 failing to recognize a marker while descending, an operation of further lowering the wire is repeatedly performed until the marker is recognized (in step 300-a). On the other hand, based on the marker being recognized, the delivery box is switched to a state in which the delivery box can perform precise position control with the marker as a reference.

Based on the marker being recognized, auxiliary propellers 431 provided in the delivery box 450 are deployed, and the delivery box 450 is controlled to move above the marker through driving of the auxiliary propellers (step 400-b) (step 400-c). At this time, the delivery box control system 400 calculates a relative position error between the marker and the delivery box 450 and performs horizontal movement and attitude control of the delivery box 450 so as to reduce the relative position error.

Based on the relative position error not being reduced to a value equal to or less than a reference value even by driving of the auxiliary propellers of the delivery box 450 (step 400-d), the delivery box control system 400 accumulates the calculated relative position error to a previously calculated relative position error (step 400-e). Based on the accumulated relative position error exceeding a preset reference value (step 400-f), this indicates that the hovering position of the delivery drone is excessively separated from the marker, and thus the delivery box control system 400 requests, through communication, the delivery drone control system 200 to change the hovering position.

The delivery drone control system 200 moves the hovering position toward the marker according to the request (step 200-e), and accordingly, the relative position error between the delivery box 450 and the marker is reduced again. Based on the relative position error of the delivery box 450 being reduced to less than the reference value (step 400-d), the delivery box 450 measures a relative altitude with respect to an upper portion of the vessel using a distance sensor 412 provided on a lower side.

Based on the relative altitude reaching a preset lower limit (step 400-g), the delivery box 450 opens a hatch formed at a lower portion (step 400-h), and lowers or places the delivered goods at a designated position on the marker (step 400-i). Accordingly, precise delivery of the goods is completed.

After the delivery of the goods is completed, the delivery box 400 is controlled to ascend along the wire again, and the delivery drone 100 performs a subsequent mission or a return flight.

According to such a method, since goods can be accurately delivered to a marker position through precise control of the delivery box itself without the delivery drone 100 directly landing on the vessel, safety in a marine environment and delivery accuracy can be simultaneously improved.

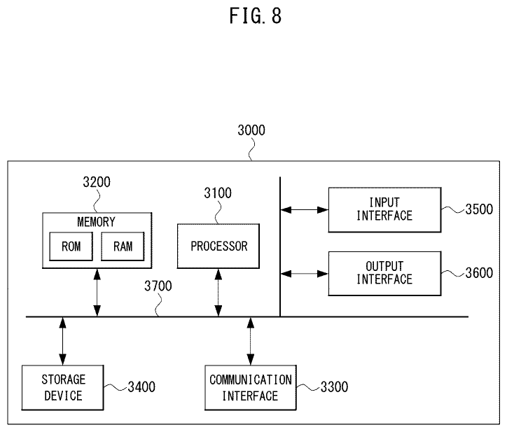

FIG. 8 is a block diagram illustrating a generalized configuration of an apparatus for performing a drone-based delivery method according to exemplary embodiments of the present disclosure.

Referring to FIG. 8, a computing system 3000 according to an exemplary embodiment of the present disclosure may comprise at least one processor 3100 and a memory 3200 storing instructions for instructing the at least one processor 3100 to perform at least one of the steps described above. At least some of the steps of the method according to an exemplary embodiment of the present disclosure may be performed by loading and executing instructions from the memory 3200 by the at least one processor 3100.

The processor 3100 may refer to a central processing unit (CPU), a graphics processing unit (GPU), or a dedicated processor in which the methods according to exemplary embodiments of the present disclosure are performed.

The drone-based delivery method performed by such a processor 3100, as described with reference to FIG. 7A and FIG. 7B, is a drone-based delivery method performed by a controller of a drone-based delivery apparatus configured to deliver goods to a marker position, and may comprise controlling a delivery drone to fly until the delivery drone reaches a target position; controlling, based on the target position being reached, the delivery drone to perform hovering; controlling a delivery box connected to the delivery drone to descend along a wire; recognizing a marker based on a downward image obtained using a sensor unit provided in the delivery box; calculating a relative position error of the delivery box with respect to the marker; accumulating the calculated relative position error to a previously calculated relative position error; until the accumulated relative position error becomes less than a reference value, calculating and accumulating the relative position error and controlling a position of the delivery box by selectively controlling at least one of flight of the delivery drone or driving of an auxiliary propulsion unit based on the accumulated relative position error; and opening a lower hatch of the delivery box such that goods are dropped to the marker position.

Such a drone-based delivery method may further comprise controlling, based on the accumulated relative position error exceeding a preset reference value, a hovering position of the delivery drone to be moved toward the marker.

Such a drone-based delivery method may further comprise controlling, based on the accumulated relative position error not exceeding the preset reference value, the auxiliary propulsion unit to be driven so as to move a position of the delivery box toward the marker.

Each of the memory 3200 and the storage device 3400 may be configured with at least one of a volatile storage medium and a non-volatile storage medium. For example, the memory 3200 may be configured with at least one of a read only memory (ROM) and a random-access memory (RAM).

In addition, the computing system 3000 may comprise a communication interface 3300 configured to perform communication through a wired and/or wireless network.

In addition, the computing system 3000 may further comprise a storage device 3400, an input interface 3500, an output interface 3600, and the like.

In addition, respective components comprised in the computing system 3000 may be connected through a bus 3700 and may communicate with each other.

A device including the processor 3100 according to an exemplary embodiment of the present disclosure may be, for example, a communicable desktop computer, a laptop computer, a notebook, a smart phone, a tablet PC, a mobile phone, a smart watch, smart glasses, an e-book reader, a portable multimedia player (PMP), a portable game device, a navigation device, a digital camera, a digital multimedia broadcasting (DMB) player, a digital audio recorder, a digital audio player, a digital video recorder, a digital video player, a personal digital assistant (PDA), etc.

Operations of the method according to an exemplary embodiment of the present disclosure may be implemented as a computer-readable program or code stored in a computer-readable recording medium. The computer-readable recording medium comprises all types of recording devices in which information readable by a computer system is stored. In addition, the computer-readable recording medium may be distributed in computer systems connected through a network, such that a computer-readable program or code may be stored and executed in a distributed manner.

In addition, the computer-readable recording medium may comprise hardware devices specially configured to store and execute program instructions, such as a ROM, a RAM, or a flash memory. Program instructions may comprise not only machine language codes generated by a compiler but also high-level language codes executable by a computer using an interpreter or the like.

Although some aspects of the present disclosure have been described in the context of an apparatus, such description may also represent a corresponding method, and blocks or devices correspond to method steps or features of the method. Similarly, aspects described in the context of a method may also be represented as corresponding blocks, items, or features of a corresponding apparatus. Some or all of the method steps may be performed by hardware devices such as, for example, a microprocessor, a programmable computer, or an electronic circuit. In some embodiments, at least one or more of the most important method steps may be performed by such a device.

In exemplary embodiments, a programmable logic device, such as a field-programmable gate array, may be used to perform some or all of the functions of the methods described herein.

In exemplary embodiments, a field-programmable gate array may operate together with a microprocessor to perform one of the methods described herein. In general, the methods are preferably performed by any suitable hardware device.

Although exemplary embodiments of the present disclosure have been described above, those skilled in the art will understand that various modifications and changes may be made without departing from the spirit and scope of the present disclosure as set forth in the appended claims.

As described above, according to the present disclosure, based on a configuration in which a marker is recognized through a sensor unit provided in a delivery box rather than through a delivery drone and a relative position error between the delivery box and the marker is calculated, obstruction of the sensor unit by the delivery box is prevented, and a delivery position can be precisely recognized, thereby providing an effect of improving delivery accuracy.

Although exemplary embodiments of the present disclosure have been described above, those skilled in the art will understand that various modifications and changes may be made without departing from the spirit and scope of the present disclosure as set forth in the appended claims.

What is claimed is:

1. A drone-based delivery apparatus for delivering goods to a marker position, comprising:
a delivery drone configured to perform hovering flight after flying to a target position;
a delivery box connected to the delivery drone to be movable upward and downward along a wire and configured to accommodate goods;
a sensor unit attached to the delivery box and configured to recognize the marker using a downward image and to calculate a relative position error of the delivery box with respect to the marker;
an auxiliary propulsion unit configured to control a horizontal position and an attitude of the delivery box based on the relative position error; and
a controller configured to, after driving the auxiliary propulsion unit, accumulate a newly measured relative position error, and to selectively control flight of the delivery drone or driving of the auxiliary propulsion unit based on an accumulated relative position error.

2. The drone-based delivery apparatus of claim 1, wherein the controller is configured to,
control a hovering position of the delivery drone to move toward the marker, based on the accumulated relative position error exceeding a preset reference value, or
drive the auxiliary propulsion unit to move a position of the delivery box toward the marker, based on the accumulated relative position error not exceeding the preset reference value.

3. The drone-based delivery apparatus of claim 1, wherein the controller comprises:
a delivery drone control system configured to control flight of the delivery drone;
a wire control system configured to control the wire that performs upward and downward movement of the delivery box; and
a delivery box control system configured to control a position and an attitude of the delivery box.

4. The drone-based delivery apparatus of claim 3, wherein the delivery drone control system comprises:
a flight control unit configured to control the delivery drone to perform hovering flight after flying to the target position; and
a hovering-position control unit configured to control movement of the hovering position of the delivery drone based on the accumulated relative position error.

5. The drone-based delivery apparatus of claim 1, wherein the sensor unit comprises one or more of:
an image sensor configured to capture a downward image of the delivery box to recognize the marker;
a distance sensor configured to measure a relative distance between the marker and the delivery box; or
a position sensor configured to identify a position of the delivery box.

6. The drone-based delivery apparatus of claim 1, wherein the auxiliary propulsion unit comprises:
a plurality of auxiliary propellers driven to perform horizontal movement and attitude control of the delivery box; and
a plurality of motors configured to respectively drive the auxiliary propellers.

7. The drone-based delivery apparatus of claim 6, wherein the auxiliary propellers are respectively disposed on both sides of the delivery box.

8. The drone-based delivery apparatus of claim 7, wherein the auxiliary propellers are respectively disposed on four side surfaces of the delivery box.

9. The drone-based delivery apparatus of claim 6, wherein the auxiliary propellers are pivotably mounted to side surfaces of the delivery box.

10. The drone-based delivery apparatus of claim 1, wherein the marker is a marker disposed on a vessel.

11. A drone-based delivery method performed by a controller of a drone-based delivery apparatus for delivering goods to a marker position, comprising:
controlling a delivery drone to fly until the delivery drone reaches a target position;
controlling the delivery drone to perform hovering, based on the target position being reached;
controlling a delivery box connected to the delivery drone to descend along a wire;
recognizing a marker based on a downward image obtained using a sensor unit attached to the delivery box;
calculating a relative position error of the delivery box with respect to the marker;
accumulating the calculated relative position error to a previously calculated relative position error;
until the accumulated relative position error becomes less than a reference value, calculating and accumulating the relative position error and controlling a position of the delivery box by selectively controlling at least one of flight of the delivery drone or driving of an auxiliary propulsion unit based on the accumulated relative position error; and
opening a lower hatch of the delivery box such that goods are dropped to the marker position.

12. The drone-based delivery method of claim 11, further comprising:
controlling, based on the accumulated relative position error exceeding a preset reference value, a hovering position of the delivery drone to be moved toward the marker.

13. The drone-based delivery method of claim 11, further comprising:
controlling, based on the accumulated relative position error not exceeding a preset reference value, the auxiliary propulsion unit to be driven to move a position of the delivery box toward the marker.

14. The drone-based delivery method of claim 11, wherein the downward image is obtained using an image sensor configured to capture a downward image of the delivery box.

15. The drone-based delivery method of claim 11, wherein the relative position error is obtained using relative distance information between the marker and the delivery box recognized based on the downward image.

16. The drone-based delivery method of claim 11, wherein the driving of the auxiliary propulsion unit is performed through driving of a plurality of auxiliary propellers comprised in the auxiliary propulsion unit.

17. The drone-based delivery method of claim 11, wherein the driving of the auxiliary propulsion unit is performed through driving of auxiliary propellers respectively disposed on both sides of the delivery box.

18. The drone-based delivery method of claim 11, wherein the driving of the auxiliary propulsion unit is performed through driving of auxiliary propellers respectively disposed on four side surfaces of the delivery box.

19. The drone-based delivery method of claim 16, wherein the driving of the auxiliary propulsion unit is performed after unfolding a plurality of propellers pivotably mounted to side surfaces of the delivery box.

20. The drone-based delivery method of claim 11, wherein the marker is a marker disposed on a vessel.
